(19) United States
(12) Patent Application Publication
(10) Pub. No.: US 2017/0011732 A1
(43) Pub. Date: Jan. 12, 2017

(54) LOW-VISION READING VISION ASSISTING SYSTEM BASED ON OCR AND TTS

(71) Applicant: Aumed Corporation, Beijing (CN)

(72) Inventor: Tieta GAO, Beijing (CN)

(21) Appl. No.: 15/155,545

(22) Filed: May 16, 2016

(30) Foreign Application Priority Data
Jul. 7, 2015 (CN) 201510395339.0

(51) Int. Cl. G10L 13/04; G10L 13/08; G06K 9/34; G10L 13/047

(52) U.S. Cl. CPC G10L 13/043; G10L 13/047; G10L 13/086; G06K 9/344

(57) ABSTRACT

A low-vision reading vision assisting system based on OCR and TTS, having an image acquisition module, a processing module and an output module. The image acquisition module is used for scanning a read object and acquiring and outputting an image. The processing module has an OCR unit and a TTS engine unit. The OCR unit is connected with the image acquisition module and used for receiving the image and performing image pre-processing and single-character recognition on the image to obtain a text file corresponding to the image. The TTS engine unit is connected with the OCR unit and used for converting the text file into an audio file; and the output module is connected with the processing module and used for synchronously outputting the text file and the audio file. The system has the advantages of convenience in use and relief in eye fatigue.

### FIELD OF THE INVENTION

The present invention relates to the technical field of electronic reading equipment, and particularly relates to a low-vision reading vision assisting system based on OCR and TTS.

### BACKGROUND OF THE INVENTION

Low-vision sufferers and the aged have trouble to different degrees when reading images and texts such as books, newspapers, documents, specifications and the like, so they depend on magnifiers traditionally. However, the magnifiers merely adopting optical magnification have the problems of limitation in magnification times, deformation at edges and the like, so the magnifiers have substantially not been used in such developed countries as Europe and the United States where high-tech products such as electronic vision assisting devices and the like for eliminating the reading obstacles of low-vision crowds are commonly used, but the vision of the low-vision crowds using eyes for a long time may be deteriorated.

With the development of terminal technology and software technology, particularly the development of intelligent terminal technology, OCR technology and TTS technology, it is feasible to combine the OCR technology with the TTS technology.

The optical character recognition (OCR for short) technology depends on the optical technology to recognize characters, and is an important technology in the field of automatic recognition technology research and application. It can automatically recognize characters and input the characters into a computer, is suitable for establishing a network library, and can display a printing book in the form of a text file by scanning the book, storing the book in a computer in the foam of a file and then recognizing required characters with OCR character recognition software.

The text to speech (TTS for short) technology relates to multiple subject technologies such as acoustics, linguistics, digital signal processing technology, multimedia technology and the like, and is an advanced technology in the field of Chinese information processing.

Compared with some application programs which produce sound by using prerecorded sound files, a sound production engine of TTS is only a few megabytes and does not need the support of a large amount of sound files, so a large storage space can be saved and any previously unknown statement can be read. Many applications realize the speech function by using the TTS technology nowadays, for example, some broadcasting software can be used for reading novels or proof-reading or reading E-mails, some electronic dictionaries can be used for reading words, and the TTS technology can be further used for automatically playing service information in query centers and the like.

### SUMMARY OF THE INVENTION

The summary of the present invention will be given below, so as to provide basic understanding on certain aspects of the present invention. It should be understood that, this summary is not exhaustive for the present invention. It does not intend to determine the key or important part of the present invention, or define the scope of the present invention. It only aims to give certain concepts in the form of simplification, and thus serves as the preface of more detailed description later.

The present invention provides a low-vision reading vision assisting system based on OCR and TTS for lowering the use frequency of eyes and realizing reading at the same time.

The present invention provides a low-vision reading vision assisting system based on OCR and TTS, including:

an image acquisition module, used for scanning a read object and acquiring and outputting an image;

a processing module, including:

an OCR unit, connected with the image acquisition module, and used for receiving the image and performing image pre-processing and single-character recognition on the image to obtain a text file corresponding to the image; and

a TTS engine unit, connected with the OCR unit, and used for converting the text file into an audio file;

an output module, connected with the processing module, and used for synchronously outputting the text file and the audio file.

The low-vision reading vision assisting system based on OCR and TTS provided by the present invention combines the OCR technology with the TTS technology, wherein the image acquisition module scans the read object and acquires the image, the processing module processes the acquired image, and the output module synchronously displays the read text and outputs the corresponding audio, thus realizing a listening-reading centered and visual assisted reading mode for a user. The user may set the display mode through a keyboard or a touch screen, such as a white-on-black, black-on-white or eye-protecting display mode, to further relieve the fatigue of eyes and assist low-vision sufferers, the aged and the blind in reading. To sum up, the present invention has the advantages of convenience in use, relief in eye fatigue and the like.

### BRIEF DESCRIPTION OF THE DRAWINGS

The above and other purposes, characteristics and advantages of the present invention will be understood more easily with reference to the accompanying drawings and the following description of the embodiments of the present invention. The components in the drawings are merely used for illustrating the principle of the present invention. In the drawings, the same or similar technical features or components will be indicated by the same or similar reference signs.

FIG. 1 is a structural schematic diagram of an embodiment of a low-vision reading vision assisting system based on OCR and TTS in the present invention.

FIG. 2 is a structural schematic diagram of a preferred embodiment of the low-vision reading vision assisting system based on OCR and TTS in the present invention.

FIG. 3 is a structural schematic diagram of another preferred embodiment of the low-vision reading vision assisting system based on OCR and TTS in the present invention.

### DESCRIPTION

In the figures:

10: image acquisition module

20: user input module

30: processing module

50: output module

301: OCR unit

303: TTS engine unit

501: display unit

503: audio output unit

### DETAILED DESCRIPTION OF THE EMBODIMENTS

The embodiments of the present invention will be described below with reference to the accompanying drawings. The elements and the features described in one drawing or embodiment of the present invention may be combined with the elements and the features in one or more other drawings or embodiments. It should be noted that, for the purpose of clearness, the components unrelated with the present invention and known by those of ordinary skill in the art and the processed expressions and description are omitted in the drawings and the description.

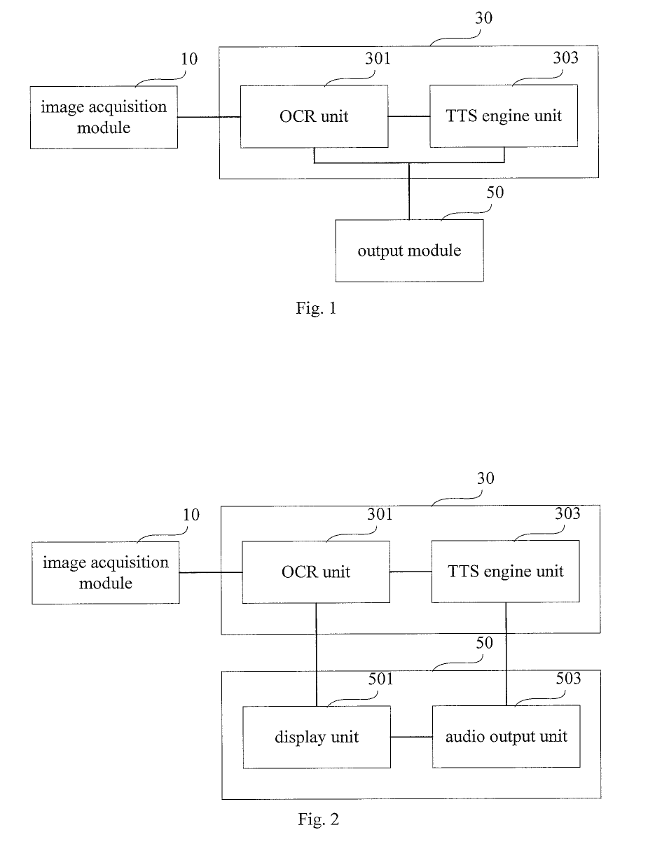

FIG. 1 is a structural schematic diagram of an embodiment of a low-vision reading vision assisting system based on OCR and TTS in the present invention.

As shown in FIG. 1, in this embodiment, the low-vision reading vision assisting system based on OCR and TTS in the present invention includes:

an image acquisition module 10, used for scanning a read object and acquiring and outputting an image;

a processing module 30, including:

an OCR unit 301, connected with the image acquisition module 10, and used for receiving the image and performing image pre-processing and single-character recognition on the image to obtain a text file corresponding to the image; and

a TTS engine unit 303, connected with the OCR unit 301, and used for converting the text file into an audio file; and

an output module 50, connected with the processing module 30, and used for synchronously outputting the text file and the audio file.

Specifically, the image acquisition module 10 is generally a scanner, a camera or other scanning/shooting equipment with the same function; and a read object such as newspaper, a book and the like is acquired and input into a computer by the image acquisition module 10, so that digitalization of the manuscript is realized. The premise of OCR accuracy is high scanning quality of a document image. Appropriately selecting the scanning resolution, relevant parameters and higher camera resolution is the key of ensuring that character images are clear and features are not lost. Moreover, the read object to be scanned is placed as correctly as possible, to ensure a small preprocessed detected inclination angle, so that character images are deformed little after inclination correction. The OCR accuracy can be improved by these simple operations. Otherwise, images of half characters may be detected due to improper scanning setting and excessive broken strokes of characters; and part of features may be lost due to broken strokes and stroke adhesion of characters, so that when the features of the character images are compared with a feature library, the features may be greatly different and the recognition error rate is high.

Image pre-processing is to detect each character image in the received image and do some preparation work before single-character recognition, including image purification, namely, removing noise (interference) from the original image, measuring the inclination angle of a document, analyzing the layout of the document, confirming the layout of the selected character domain, segmenting horizontal and vertical characters, separating character images in each row, judging punctuations and the like. The pre-processing step in this phase is very important, and the processing effect directly influences the accuracy of character recognition.

Single-character recognition is to convert the character images into standard codes of characters by a computer, namely, the so-called recognition technology. Such feature information as structure, stroke and the like of characters is pre-stored in the system, analysis is made according to the stroke, feature point, projection information, point area distribution and the like of the characters, the recognized characters or multiple recognition results are matched up and down in a phrase mode, and the single-character recognition result is subjected to word segmentation and is compared with the phrases in the lexicon, so that the recognition rate of the system is improved, the recognition error rate is reduced, and a text file composed of characters is finally obtained.

The TTS engine unit 303 converts the text file into an audio file and outputs the audio file, and this process is mainly to decompose the characters or words in the text file into phonemes, analyze symbols to be specially processed, such as number, monetary unit, word modification, punctuation and the like in the text file, and generate digital audio from the phonemes to obtain the audio file.

FIG. 2 is a structural schematic diagram of a preferred embodiment of the embodiment shown in FIG. 1.

As shown in FIG. 2, compared with the embodiment shown in FIG. 1, the output module 50 in the embodiment shown in FIG. 2 includes:

a display unit 501, connected with the OCR unit 301, and used for outputting the text file; and

an audio output unit 503, connected with the TTS engine unit 303 and the display unit 501, and used for outputting the audio file.

Specifically, the output mode of the output module 50 includes VGA (Video Graphics Array) and audio synchronous output, or HDMI (High-Definition Multimedia Interface) output.

The display unit 501 is generally a display screen, and the audio output unit 503 is generally an audio output device such as a sound, a loudspeaker and the like.

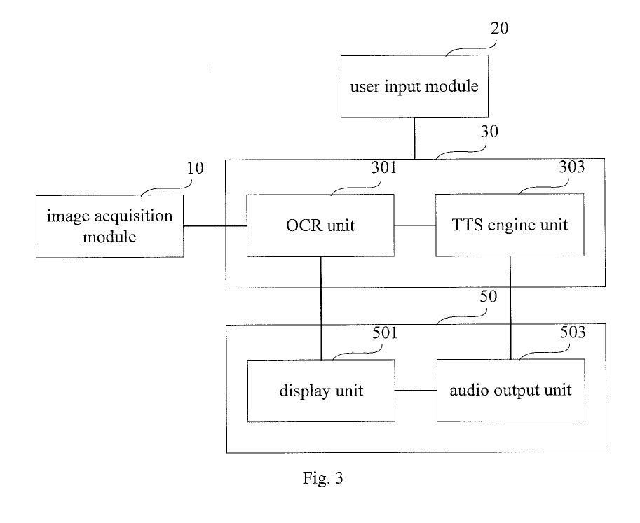

FIG. 3 is a structural schematic diagram of a preferred embodiment of the embodiment shown in FIG. 2.

As shown in FIG. 3, compared with the embodiment shown in FIG. 2, the low-vision reading vision assisting system based on OCR and TTS in the embodiment shown in FIG. 3 further includes:

a user input module 20, connected with the processing module 30, used for inputting a system start instruction, a system shutdown instruction, an output mode setting instruction and an output parameter setting instruction.

Specifically, the user input module 20 is generally a key, an external keyboard, a mouse or a touch screen on a device.

Preferably, the image acquisition module 10 is further used for acquiring and outputting video of the read object.

Preferably, the OCR unit 301 is further used for acquiring images in the video according to preset parameters.

Preferably, the output module 50 is further used for outputting the video.

Preferably, the OCR unit 301 is further used for judging the language species of characters included in the images during image pre-processing, calling a corresponding language library to carry out single-character recognition, and sending the language species information to the TTS engine unit 303.

Preferably, the TTS engine unit 303 is further used for calling a speech library of the corresponding language according to the language species information to perform text to speech conversion.

In conclusion, the low-vision reading vision assisting system based on OCR and TTS provided by the present invention combines the OCR technology with the TTS technology, wherein the image acquisition module scans the read object and acquires the image, the processing module processes the acquired image, and the output module synchronously displays the read text and outputs the corresponding audio, thus realizing a listening-reading centered and visual assisted reading mode for a user.

The user may set the display mode through a keyboard or a touch screen, such as a white-on-black, black-on-white or eye-protecting display mode, to further relieve the fatigue of eyes and assist low-vision sufferers, the aged and the blind in reading. The present invention has the advantages of convenience in use, relief in eye fatigue and the like.

Finally, it should be noted that, the above embodiments are merely used for illustrating the technical solutions of the present invention, rather than limiting the present invention; although the present invention is illustrated in detail with reference to the aforementioned embodiments, it should be understood by those of ordinary skill in the art that modifications may still be made on the technical solutions described in the aforementioned respective embodiments, or equivalent substitutions may be made to a part of technical characteristics thereof; and these modifications or substitutions do not make the nature of the corresponding technical solutions depart from the spirit and scope of the technical solutions of the respective embodiments of the present invention.

1. A low-vision reading vision assisting system based on OCR and TTS, comprising:
an image acquisition module, used for scanning a read object and acquiring and outputting an image;
a processing module, comprising:
an OCR unit, connected with the image acquisition module, and used for receiving the image and performing image pre-processing and single-character recognition on the image to obtain a text file corresponding to the image; and
a TTS engine unit, connected with the OCR unit, and used for converting the text file into an audio file; and
an output module, connected with the processing module, and used for synchronously outputting the text file and the audio file.

2. The low-vision reading vision assisting system of claim 1, wherein the output module comprises:
a display unit, connected with the OCR unit, and used for outputting the text file; and
an audio output unit, connected with the TTS engine unit and the display unit, and used for outputting the audio file.

3. The low-vision reading vision assisting system of claim 1, further comprising:
a user input module, connected with the processing module, used for inputting a system start instruction, a system shutdown instruction, an output mode setting instruction and an output parameter setting instruction.

4. The low-vision reading vision assisting system of claim 1, wherein the image acquisition module is further used for acquiring and outputting video of the read object.

5. The low-vision reading vision assisting system of claim 4, wherein the OCR unit is further used for acquiring images in the video according to preset parameters.

6. The low-vision reading vision assisting system of claim 4, wherein the output module is further used for outputting the video.

7. The low-vision reading vision assisting system of claim 1, wherein the OCR unit is further used for judging the language species of characters included in the images during image pre-processing, calling a corresponding language library to carry out single-character recognition, and sending the language species information to the TTS engine unit.

8. The low-vision reading vision assisting system of claim 7, wherein the TTS engine unit is further used for calling a speech library of the corresponding language according to the language species information to perform text to speech conversion.

9. The low-vision reading vision assisting system of claim 1, wherein the output mode of the output module comprises VGA and audio synchronous output, or HDMI output.
